(19) United States
(12) Patent Application Publication
(10) Pub. No.: US 2025/0370713 A1
(43) Pub. Date: Dec. 4, 2025

(54) ELECTRONIC DEVICE FOR PERFORMING QUANTIZATION BY USING MULTIPLIER AND ACCUMULATOR, AND CONTROL METHOD THEREFOR

(71) Applicant: Samsung Electronics Co., Ltd., Suwon-si (KR)

(72) Inventors: Jinhwan BAIK, Suwon-si (KR); Jonghun LEE, Suwon-si (KR); Jaeun PARK, Suwon-si (KR); Cheolgyu JIN, Suwon-si (KR)

(21) Appl. No.: 19/240,513

(22) Filed: Jun. 17, 2025

Related U.S. Application Data
(63) Continuation of application No. PCT/KR2023/020292, filed on Dec. 11, 2023.

(30) Foreign Application Priority Data
Jan. 31, 2023 (KR) 10-2023-0012931

(51) Int. Cl. G06F 7/523; G06F 5/01; G06F 7/50

(52) U.S. Cl. CPC G06F 7/523; G06F 5/01; G06F 7/50

(57) ABSTRACT

An electronic device is provided. The electronic device includes memory, a processor, the processor including a multiplier, and an accumulator, wherein the instructions, when executed by the at least one processor individually or collectively, cause the electronic device to obtain multiplicand data according to a convolution operation between an activation value and a weight value by using the multiplier and the accumulator and store the data in the memory, based on a first scale factor for quantizing the activation value, a second scale factor for quantizing the weight value, and a third scale factor for quantizing the multiplicand data, obtain multiplier data and a bit shift factor and store them in the memory, and obtain an integer that quantized the multiplicand data according to a multiplication operation between the multiplicand data, the multiplier data and the bit shift factor stored in the memory by using the multiplier.

### CROSS-REFERENCE TO RELATED APPLICATION(S)

This application is a continuation application, claiming priority under 35 U.S.C. § 365 (c), of an International application No. PCT/KR2023/020292, filed on Dec. 11, 2023, which is based on and claims the benefit of a Korean patent application number 10-2023-0012931, filed on Jan. 31, 2023, in the Korean Intellectual Property Office, the disclosure of which is incorporated by reference herein in its entirety.

### BACKGROUND

### 1. Field

The disclosure relates to an electronic device and a control method therefor. More particularly, the disclosure relates to an electronic device that performs quantization by using a multiplier and an accumulator, and a control method therefor.

### 2. Description of Related Art

For a conventional artificial intelligence model to perform quantization, there was a problem that a multiplier dedicated to quantization which can perform operations of relatively bigger bits than a multiplier used in a multiplication operation process (e.g., a multiplier of a multiplier-accumulator (MAC)) had to be used.

A multiplier dedicated to quantization which can perform operations of big bits had a problem of increasing the size of a processor (e.g., a chip) included in an electronic device.

For example, in the case of a conventional electronic device, if a multiplication-accumulation operation, i.e., a convolution operation between 32(25) input feature maps of 8bits and weights of 8bits needed to be performed, a multiplier of a multiplier-accumulator (MAC) needed to perform a multiplication operation of 8bits×8bits, and if a result of the accumulator of performing an accumulation operation was 21bits (8bits+8bits+5), a multiplier dedicated to quantization needed to perform a multiplication operation of 21bits×32bits, and thus there was a problem that the multiplier dedicated to quantization required a bigger area than the multiplier of the multiplier-accumulator.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device that performs quantization by using a multiplier and an accumulator, and a control method therefor.

Additional aspects will be set forth in part in the description which follows and, in part, will be apparent from the description, or may be learned by practice of the presented embodiments.

In accordance with an aspect of the disclosure, an electronic device is provided. The electronic device includes memory, comprising one or more storage media, storing instructions, and at least one processor communicatively coupled to the memory, the at least one processor including a multiplier and an accumulator, wherein the instructions, when executed by the at least one processor individually or collectively, cause the electronic device to obtain multiplicand data according to a convolution operation between an activation value and a weight value by using the multiplier and the accumulator, and store the data in the memory, based on a first scale factor for quantizing the activation value, second scale factor for quantizing the weight value, and a third scale factor for quantizing the multiplicand data, obtain multiplier data and a bit shift factor, and store the multiplier data and a bit shift factor in the memory, and obtain an integer that quantized the multiplicand data according to a multiplication operation among the multiplicand data, the multiplier data, and the bit shift factor stored in the memory by using the multiplier.

In accordance with another aspect of the disclosure, a method performed by an electronic device is provided. The control method includes obtaining, by the electronic device, multiplicand data according to a convolution operation between an activation value and a weight value by using a multiplier and an accumulator, and storing, by the electronic device, the data in memory, and based on a first scale factor for quantizing the activation value, a second scale factor for quantizing the weight value, and a third scale factor for quantizing the multiplicand data, obtaining, by the electronic device, multiplier data and a bit shift factor, and storing the multiplier data and a bit shift factor in the memory, and obtaining, by the electronic device, an integer that quantized the multiplicand data according to a multiplication operation among the multiplicand data, the multiplier data, and the bit shift factor by using the multiplier.

In accordance with another aspect of the disclosure, one or more non-transitory computer-readable recording media storing one or more computer programs including computer-executable instructions that, when executed by one or more processors of an electronic device, individually or collectively, cause the control method for an electronic device to perform operations are provided. The operations include obtaining, by the electronic device, multiplicand data according to a convolution operation between an activation value and a weight value by using a multiplier and an accumulator, and storing, by the electronic device, the data in memory, based on a first scale factor for quantizing the activation value, a second scale factor for quantizing the weight value, and a third scale factor for quantizing the multiplicand data, obtaining, by the electronic device, multiplier data and a bit shift factor, and storing the multiplier data and a bit shift factor in the memory, and obtaining, by the electronic device, an integer that quantized the multiplicand data according to a multiplication operation among the multiplicand data, the multiplier data, and the bit shift factor by using the multiplier.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for illustrating an electronic device that performs quantization according to the related art;

FIG. 2 is a block diagram for illustrating a configuration of an electronic device according to an embodiment of the disclosure;

FIG. 3 is a detailed block diagram for illustrating a configuration of an electronic device according to an embodiment of the disclosure;

FIG. 4 is a diagram for illustrating multiplicand data and multiplier data according to an embodiment of the disclosure;

FIG. 5 is a diagram for illustrating multiplicand data and multiplier data divided in units of digits corresponding to a first bit according to an embodiment of the disclosure;

FIG. 6 is a diagram for illustrating a multiplication operation between multiplicand data and multiplier data according to an embodiment of the disclosure;

FIG. 7 is a diagram for illustrating a plurality of combinations according to a multiplication operation according to an embodiment of the disclosure;

FIG. 8 is a diagram for illustrating a plurality of groups that grouped a plurality of combinations according to an embodiment of the disclosure;

FIG. 9 is a diagram for illustrating an accumulation operation among a plurality of groups according to an embodiment of the disclosure;

FIG. 10 is a diagram for illustrating a condition for ending an operation according to an embodiment of the disclosure;

FIG. 11 is a diagram for illustrating a condition for ending an operation according to an embodiment of the disclosure;

FIG. 12 is a diagram for illustrating multiplicand data and multiplier data of 24bits according to an embodiment of the disclosure;

FIG. 13 is a diagram for illustrating operation orders of each of a plurality of combinations according to a multiplication operation according to an embodiment of the disclosure;

FIG. 14 is a diagram for illustrating operation results of each of a plurality of combinations according to an embodiment of the disclosure;

FIG. 15 is a diagram for illustrating an operation result according to information on the number of times of repetition according to an embodiment of the disclosure; and

FIG. 16 is a diagram for illustrating a method of obtaining an integer that quantized multiplicand data according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include all modifications, equivalents, or alternatives of the embodiments included in the ideas and the technical scopes disclosed herein. Meanwhile, in case it is determined that in describing embodiments, detailed explanation of related known technologies may unnecessarily confuse the gist of the disclosure, the detailed explanation will be omitted.

In addition, terms such as “first,” “second,” and the like may be used to describe various components, but the components are not intended to be limited by the terms. The terms are used only to distinguish one component from another component.

Also, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Also, in the disclosure, “a module” or “a part” performs at least one function or operation, and may be implemented as hardware or software, or as a combination of hardware and software. In addition, a plurality of “modules” or “parts” may be integrated into at least one module and implemented as at least one processor (not shown), except “a module” or “a part” that needs to be implemented as specific hardware.

Hereinafter, the embodiments of the disclosure will be described in detail with reference to the accompanying drawings, such that those having ordinary skill in the art to which the disclosure belongs can easily carry out the disclosure. However, it should be noted that the disclosure may be implemented in various different forms, and is not limited to the embodiments described herein. Also, in the drawings, parts that are not related to explanation were omitted, for explaining the disclosure clearly, and throughout the specification, similar components were designated by similar reference numerals.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

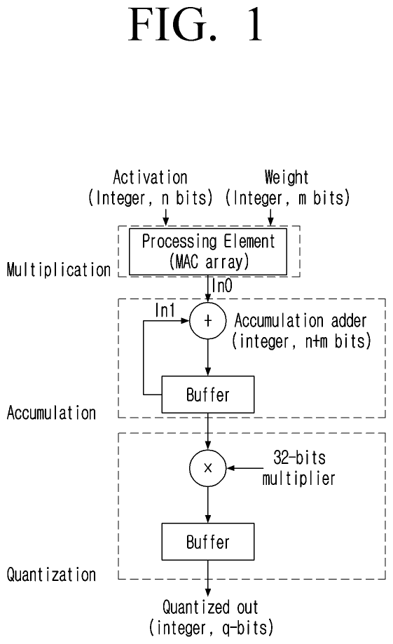

FIG. 1 is a diagram for illustrating an electronic device that performs quantization according to the related art.

Referring to FIG. 1, a conventional artificial intelligence model performed quantization for reducing the amount of data to be processed, and improving the processing speed.

As an example, for using an artificial intelligence model trained by using a high performance computer such as a server (or, a cloud server) in an electronic device (e.g., a user terminal device), the weight of the artificial intelligence model may be reduced by using a post-quantization method. For example, an integer-only quantization method that compresses an artificial intelligence model by using only numbers in an integer form is being utilized generally.

According to an embodiment, a user terminal device may output a result of performing an artificial intelligence inference operation of multiplication, accumulation, and quantization by using a light-weighted artificial intelligence model.

However, for a conventional light-weighted artificial intelligence model to perform quantization, there was a problem that a multiplier dedicated to quantization which can perform operations of relatively bigger bits than a multiplier used in a multiplication operation process (e.g., a multiplier of a multiplier-accumulator (MAC)) had to be used. Also, a multiplier dedicated to quantization which can perform operations of big bits had a problem of increasing the size of a processor (e.g., a chip) included in an electronic device.

For example, in the integer-only quantization method, input data in an integer form is not dequantized to data in a real number form, but a result of performing an inference operation may be requantized to data in an integer form, and output.

For example, in the case of a conventional electronic device, if a multiplication-accumulation operation, i.e., a convolution operation between 32 (2⁵) input feature maps of 8bits and weights of 8bits is performed, a multiplier of a multiplier-accumulator (MAC) may perform a multiplication operation of 8bits×8bits, and a result of the accumulator of performing an accumulation operation may be 21bits (8bits+8bits+5).

According to an embodiment, a conventional electronic device may perform quantization of multiplying a result of 21bits of performing multiplication and accumulation operations (an output of the accumulator (output)=Pₛᵤₘ (P-bits)) by a value of 32bits, and shifting the value.

For example, an operation of multiplying data in an integer form of 32bits by b/a (i.e., an output of the accumulator (output)×b/a) may be replaced by an operation of multiplying data in an integer form of 32bits by bxMs and a shift operation (>>ms) (i.e., an output of the accumulator (output)×(b×Ms)>>ms=Quantization output (Q-bits)).

Accordingly, the multiplier dedicated to quantization according to an embodiment should perform a multiplication operation of 21bits×32bits, and thus there was a problem that it required a bigger area than a multiplier of a multiplier-accumulator (MAC).

Hereinafter, a processor (e.g., a neural processing unit (NPU)) that performs quantization by using a multiplier-accumulator (MAC) without a multiplier dedicated to quantization that requires a relatively bigger area according to various embodiments of the disclosure will be explained.

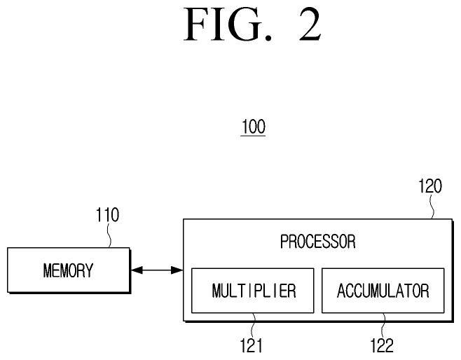

FIG. 2 is a block diagram for illustrating a configuration of an electronic device according to an embodiment of the disclosure.

Referring to FIG. 2, an electronic device 100 may include memory 110 and a processor 120.

According to an embodiment, the memory 110 is a volatile storage medium, and requires supply of electricity for maintaining the stored information (e.g., an execution code and data). As an example, the memory 110 may be implemented as random access memory (RAM). According to an embodiment, the memory 110 may be referred to as cache memory, buffer memory, etc., but hereinafter, it will be generally referred to as the memory 110 for the convenience of explanation. Meanwhile, the memory 110 is not limited to a volatile storage medium, and it can obviously be implemented as a non-volatile storage medium such as non-volatile memory, flash-memory, a hard disc drive (HDD), or a solid state drive (SSD), etc.

According to an embodiment, the processor 120 controls overall operations of the electronic device 100.

According to an embodiment of the disclosure, the processor 120 may be implemented as a digital signal processor (DSP) processing digital signals, a microprocessor, and a timing controller (TCON). However, the disclosure is not limited thereto, and the processor 120 may include one or more of a central processing unit (CPU), a micro controller unit (MCU), a micro processing unit (MPU), a controller, an application processor (AP) or a communication processor (CP), an ARM processor, and an artificial intelligence (AI) processor, or may be defined by the terms. Also, the processor 120 may be implemented as a system on chip (SoC) having a processing algorithm stored therein or large scale integration (LSI), or in the form of a field programmable gate array (FPGA). The processor 120 may perform various functions by executing computer executable instructions stored in the memory 110.

The processor 120 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The processor 120 may control one or a random combination of the other components of the electronic device, and perform an operation related to communication or data processing. Also, the processor 120 may execute one or more programs or instructions stored in the memory 110. For example, the processor 120 performs the method according to an embodiment of the disclosure by executing the one or more instructions stored in the memory 110.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation are performed by the first processor (e.g., a generic-purpose processor), and the third operation may be performed by a second processor (e.g., an artificial intelligence-dedicated processor).

The processor 120 may be implemented as a single core processor including one core, or may be implemented as one or more multicore processors including a plurality of cores (e.g., multicores of the same kind or multicores of different kinds). In case the processor 120 is implemented as multicore processors, each of the plurality of cores included in the multicore processors may include internal memory of the processor such as cache memory, on-chip memory, etc., and common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation are performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) wherein at least one processor and other electronic components are integrated, a single core processor, a multicore processor, or a core included in the single core processor or the multicore processor. Also, the core may be implemented as a CPU, a GPU, an APU, a MIC, a DSP, an NPU, a hardware accelerator, or a machine learning accelerator, etc., but the embodiments of the disclosure are not limited thereto.

Meanwhile, functions related to artificial intelligence according to the disclosure are operated through the processor 120 and the memory 110 of the electronic device 100. The processor 120 may consist of one or a plurality of processors. The one or plurality of processors may include at least one of a central processing unit (CPU), a graphics processing unit (GPU), or a neural processing unit (NPU), but is not limited to the aforementioned embodiments of the processor.

A CPU is a generic-purpose processor that can perform not only general operations but also artificial intelligence operations, and it can effectively execute a complex program through a multilayer cache structure. A CPU is advantageous for a serial processing method that enables a systemic linking between the previous calculation result and the next calculation result through sequential calculations. A generic-purpose processor is not limited to the aforementioned examples excluding cases wherein it is specified as the aforementioned CPU.

A GPU is a processor for mass operations such as a floating point operation used for graphic processing, etc., and it can perform mass operations in parallel by massively integrating cores. In particular, a GPU may be advantageous for a parallel processing method such as a convolution operation, etc. compared to a CPU. Also, a GPU may be used as a co-processor for supplementing the function of a CPU. A processor for mass operations is not limited to the aforementioned examples excluding cases wherein it is specified as the aforementioned GPU.

An NPU is a processor specialized for an artificial intelligence operation using an artificial neural network, and it can implement each layer constituting an artificial neural network as hardware (e.g., silicon). The NPU is designed to be specialized according to the required specification of a company, and thus it has a lower degree of freedom compared to a CPU or a GPU, but it can effectively process an artificial intelligence operation required by the company. Meanwhile, as a processor specialized for an artificial intelligence operation, an NPU may be implemented in various forms such as a tensor processing unit (TPU), an intelligence processing unit (IPU), a vision processing unit (VPU), etc. An artificial intelligence processor is not limited to the aforementioned examples excluding cases wherein it is specified as the aforementioned NPU.

Also, the one or plurality of processors may be implemented as a system on chip (SoC). In the SoC, the memory, and a network interface such as a bus for data communication between the processor and the memory, etc. may be further included other than the one or plurality of processors.

In case a plurality of processors are included in the system on chip (SoC) included in the electronic device 100, the electronic device 100 may perform an operation related to artificial intelligence (e.g., an operation related to learning or inference of an artificial intelligence model) by using some processors among the plurality of processors. For example, the electronic device 100 performs an operation related to artificial intelligence by using at least one of a GPU, an NPU, a VPU, a TPU, or a hardware accelerator specialized for artificial intelligence operations such as a convolution operation, a matrix product operation, etc. among the plurality of processors. However, this is merely an example, and the electronic device 100 can obviously process an operation related to artificial intelligence by using a generic-purpose processor such as a CPU, etc.

Also, the electronic device 100 may perform operations regarding functions related to artificial intelligence by using a multicore (e.g., a dual core, a quad core, etc.) included in one processor. In particular, the electronic device 100 may perform artificial intelligence operations such as a convolution operation, a matrix product operation, etc. in parallel by using the multicore included in the processor 120.

The one or plurality of processors may perform control to process input data according to predefined operation rules or an artificial intelligence model stored in the memory 110. The predefined operation rules or the artificial intelligence model are characterized in that they are made through learning.

Being made through learning means that predefined operation rules or an artificial intelligence model having desired characteristics are made by applying a learning algorithm to a plurality of training data. Such learning may be performed in a device itself wherein artificial intelligence is performed according to the disclosure, or through a separate server/system.

An artificial intelligence model may consist of a plurality of neural network layers. At least one layer has at least one weight value, and performs an operation of the layer through the operation result of the previous layer and at least one defined operation. As examples of a neural network, there are a convolutional neural network (CNN), a deep neural network (DNN), a recurrent neural network (RNN), a restricted Boltzmann Machine (RBM), a deep belief network (DBN), a bidirectional recurrent deep neural network (BRDNN), deep Q-networks, and a transformer, but the neural network in the disclosure is not limited to the aforementioned examples excluding specified cases.

A learning algorithm is a method of training a specific subject device (e.g., a robot) by using a plurality of training data and thereby making the specific subject device make a decision or make prediction by itself. As examples of learning algorithms, there are supervised learning, unsupervised learning, semi-supervised learning, or reinforcement learning, but learning algorithms in the disclosure are not limited to the aforementioned examples excluding specified cases.

The processor 120 according to an embodiment of the disclosure may include a multiplier 121 and an accumulator 122.

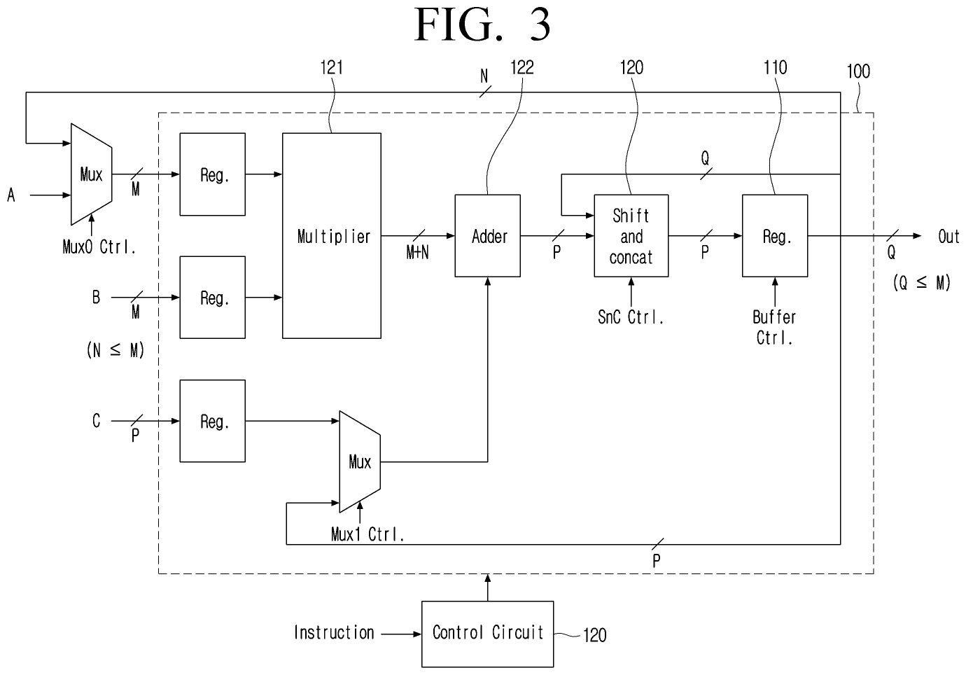

Referring to FIG. 3, the processor 120 that performs quantization by using the multiplier 121 and the accumulator 122 will be explained.

FIG. 3 is a detailed block diagram for illustrating a configuration of an electronic device according to an embodiment of the disclosure.

Referring to FIG. 3, the processor 120 may include a multiplier 121 of a MAC, and an accumulator (or an adder) 122. In FIG. 3, the transmission direction of data was schematized with an arrow for the convenience of explanation, and bits of the transmitted data were illustrated in the lower part of the arrow.

First, the processor 120 may store an activation value of N-bits in a register (Reg), and store a weight value of M-bits in the register (Reg).

Then, the processor 120 may obtain multiplicand data of P-bits according to a multiplication-accumulation operation, i.e., a convolution operation between the activation value and the weight value using the multiplier 121 and the accumulator 122.

The multiplicand data of P-bits is expressed as an equation as follows.

First, a quantized activation value Iqnt (e.g., an input feature map) and a quantized weight value Fqnt (e.g., a filter) are input into the processor 120, and the relation between the actual values (i.e., the actual activation value i, the actual weight value f) and the quantized values may be expressed as the following Equation 1 and Equation 2.

$${I}_{qnt} [ w ] [ h ] = ( i [ w ] [ h ] - {ZeroPoint}_{i} ) \times {scale}_{i} \qquad Equation 1$$

$$i [ w ] [ h ] = ( {I}_{qnt} [ w ] [ h ] + {ZeroPoint}_{i} ) / {scale}_{i}$$

$${F}_{qnt} [ w ] [ h ] = ( f [ w ] [ h ] - {ZeroPoint}_{f} ) \times {scale}_{f} \qquad Equation 2$$

$$f [ w ] [ h ] = ( {F}_{qnt} [ w ] [ h ] + {ZeroPoint}_{f} ) / {scale}_{f}$$

Then, an output value before quantization (e.g., an output feature map) o [w][h] may be expressed as the following Equation 3.

$$o [ w ] [ h ] = {\sum }_{c = 0}^{C - 1} {\sum }_{r = 0}^{R - 1} {\sum }_{s = 0}^{S - 1} i [ c ] [ w + r ] [ h + s ] \times f [ c ] [ r ] [ s ] \qquad [ Equation 3 ]$$

$$o [ w ] [ h ] = \frac{1}{{scale}_{i} \times {scale}_{f}} {\sum }_{c = 0}^{C - 1} {\sum }_{r = 0}^{R - 1} {\sum }_{s = 0}^{S - 1} {I}_{q n t} [ c ] [ w + r ] [ h + s ] \times {F}_{qnt} [ c ] [ r ] [ s ]$$

If the input feature map, the filter, and the output feature map are assumed as symmetric data for the convenience of explanation, each of ZeroPointᵢ, ZeroPoint_{f}, and ZeroPointₒ may be 0.

Then, the output value is quantized, and the quantization may be expressed as the following Equation 4.

$${O}_{qnt} [ w ] [ h ] = ( o [ w ] [ h ] - Z e r o P o i n {t}_{o} ) \times {scale}_{o}$$

$${O}_{q n t} [ w ] [ h ] = \frac{{scale}_{o}}{{scale}_{i} \times {scale}_{f}} {\sum }_{c = 0}^{C - 1} {\sum }_{r = 0}^{R - 1} {\sum }_{s = 0}^{S - 1} {I}_{qnt} [ c ] [ w + r ] [ h + s ] \times {F}_{qnt} [ c ] [ r ] [ s ]$$

Oqnt [w][h] may be the quantized output value.

Meanwhile, the processor 120 may replace a division operation by a multiplication operation and a shift operation as in the following Equation 5.

$$1 / s = {M}_{s} \times {2}^{- m s} \qquad Equation 5$$

$$\frac{{scale}_{o}}{{scale}_{i} \times {scale}_{f}} \approx {M}_{s} \times {2}^{- m s}$$

Accordingly, the quantized output value may be expressed as the following Equation 6.

$${O}_{q n t} [ w ] [ h ] = ( {M}_{s} {\sum }_{c = 0}^{C - 1} {\sum }_{r = 0}^{R - 1} {\sum }_{s = 0}^{S - 1} {I}_{q n t} [ c ] [ w + r ] [ h + s ] \times {F}_{q n t} [ c ] [ r ] [ s ] ) \times {2}^{- m s} \qquad Equation 6$$

Meanwhile, as illustrated in FIG. 3, the processor 120 may obtain a requantized output value by using the multiplier 121 and the accumulator 122, without using a multiplier dedicated to quantization after the convolution operation.

The requantized output value Oqnt [w][h] may be expressed as the following Equation 7.

$${O}_{q n t} [ w ] [ h ] = ( {M}_{s} {P}_{sum} [ w ] [ h ] ) \times {2}^{- m s} \qquad Equation 7$$

Pₛᵤₘ may be multiplicand data of P-bits (i.e., a result value of the convolution operation), and Ms may be multiplier data of Ms-bits, and a result value of a multiplication operation between Psum and Ms may be data of (P+Ms)-bits.

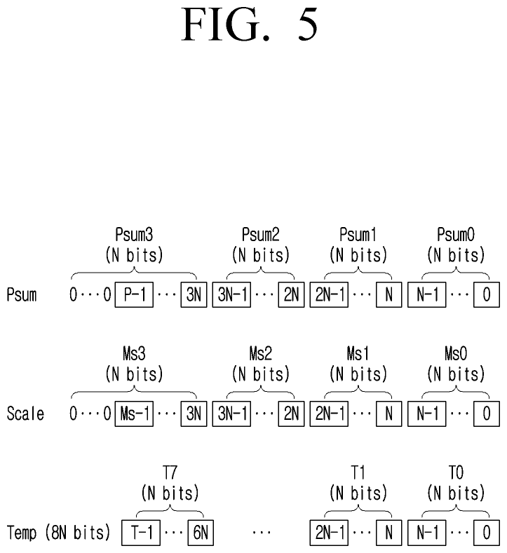

Meanwhile, referring to FIG. 5, the processor 120 may obtain multiplicand data Ms and a bit shift factor 2^{-ms} based on a first scale factor scale; for quantizing the activation value, a second scale factor scaler for quantizing the weight value, and a third scale factor scale for quantizing the multiplicand data Psum.

Then, the processor 120 may obtain an integer that quantized the multiplicand data Psum as an output value according to a multiplication operation among the multiplicand data Psum, the multiplier data Ms, and the bit shift factor 2^{-ms} by using the multiplier 121, but not a multiplier dedicated to quantization.

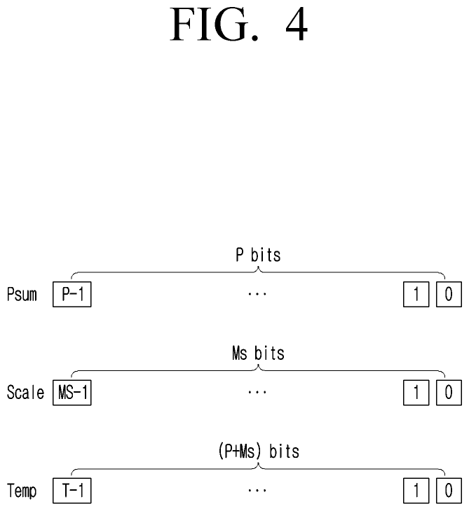

FIG. 4 is a diagram for illustrating multiplicand data and multiplier data according to an embodiment of the disclosure.

Referring to FIG. 4, the multiplicand data Psum may be data of P-bits, and the multiplier data Ms may be data of Ms-bits.

Also, before performing a shift operation, a result value Temp according to a multiplication operation between the multiplicand data Psum and the multiplier data Ms may be data of (P+Ms)-bits.

Meanwhile, the processor 120 according to an embodiment of the disclosure performs a multiplication operation by using the multiplier 121, but not a multiplier dedicated to quantization, and thus the multiplier 121 cannot perform a multiplication operation of P-bits×Ms-bits.

Hereinafter, a method for the processor 120 to obtain a result value Temp according to a multiplication operation between the multiplicand data Psum and the multiplier data Ms, i.e., an integer that quantized the multiplicand data Psum by using the multiplier 121, although the multiplier 121 does not perform a multiplication operation of P-bits×Ms-bits will be explained.

FIG. 5 is a diagram for illustrating multiplicand data and multiplier data divided in units of digits corresponding to a first bit according to an embodiment of the disclosure.

Referring to FIG. 5, the processor 120 according to an embodiment may divide the multiplicand data Psum into units of digits corresponding to a first bit, and obtain at least one first parameter.

For example, the processor 120 divides the multiplicand data Psum of P-bits into units of digits corresponding to N-bits, and obtain a plurality of first parameters Psum0 to Psum3.

Psum0 among the plurality of first parameters may include digits corresponding to 2⁰ to 2ⁿ⁻¹ in the multiplicand data Psum. Also, Psum1 among the plurality of first parameters may include digits corresponding to 2ⁿ to 2²ⁿ⁻¹ in the multiplicand data Psum.

Accordingly, Psumα among the plurality of first parameters may include digits corresponding to 2^{α*n} to 2^{(α+1)*n-1} in the multiplicand data Psum.

Referring to FIG. 5, the processor 120 according to an embodiment may divide the multiplier data Ms into units of digits corresponding to the first bit, and obtain at least one second parameter.

For example, the processor 120 divides the multiplier data Ms of Ms-bits into units of digits corresponding to N-bits, and obtain a plurality of second parameters Ms0 to Ms3.

Ms0 among the plurality of second parameters may include digits corresponding to 2⁰ to 2ⁿ⁻¹ in the multiplier data Ms. Also, Ms1 among the plurality of second parameters may include digits corresponding to 2ⁿ to 2²ⁿ⁻¹ in the multiplier data Ms.

Accordingly, Msβ among the plurality of second parameters may include digits corresponding to 2^{β*n} to 2^{(β+1)*n-1} in the multiplier data Ms.

Then, the processor 120 may identify a plurality of combinations according to a multiplication operation between the plurality of first parameters and the plurality of second parameters. Then, the processor 120 may group the plurality of combinations into the units of the first bit, and obtain a plurality of combinations.

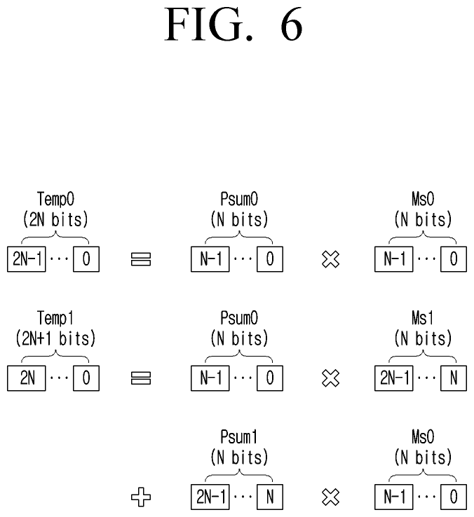

First, a plurality of combinations according to a multiplication operation between the plurality of first parameters and the plurality of second parameters will be explained with reference to FIG. 6.

FIG. 6 is a diagram for illustrating a multiplication operation between multiplicand data and multiplier data according to an embodiment of the disclosure.

Referring to FIG. 6, the multiplier 121 may perform a multiplication operation of N-bits×M-bits.

As explained in FIG. 5, when the multiplicand data Psum of P-bits is divided by N-bits (e.g., 8bits) which is the multiplicand value of the multiplier 121, it may be expressed as the following Equation 8.

$${P}_{s u m} = {P}_{s u m 3} \times {2}^{3 N} + {P}_{s u m 2} \times {2}^{2 N} + {P}_{s u m 1} \times {2}^{N} + {P}_{s u m 0} \qquad Equation 8$$

According to an embodiment, if the multiplier data Ms is M-bits which is the multiplier value of the multiplier 121, a multiplication operation between the multiplicand data Psum and the multiplier data Ms, i.e., a quantized output value Oqnt of the multiplicand data Psum may be expressed as the following Equation 9.

$${O}_{qnt} = ( ( {M}_{s} {P}_{sum 3} \times {2}^{3 N} ) + ( {M}_{s} {P}_{sum 2} \times {2}^{2 N} ) + ( {M}_{s} {P}_{sum 1} \times {2}^{N} ) + {M}_{s} {P}_{sum 0} ) \times {2}^{- m s} \qquad Equation 9$$

Each of the plurality of first parameters, i.e., Psum #is N-bits, and the multiplier data Ms is M-bits, and thus the processor 120 may obtain an operation result of Ms×Psum #by using the multiplier 121 of N-bits×M-bits, and perform a shift operation according to 2^{-ms} (i.e., shift the operation result in a binary number to the left of the number of times of ms), and thereby obtain a quantized output value Oqnt.

According to an embodiment, the processor 120 may input Psum0 included in the multiplicand data Psum and the multiplier data Ms stored in the memory 110 into the multiplier 121. Also, according to an embodiment, the processor 120 may obtain an operation result of Ms×Psum0 at the first number of times of repetition, and store the result in the memory 110.

Then, the processor 120 may obtain an operation result of (Ms×Psum1)×2N at the second number of times of repetition (e.g., perform a multiplication operation of Ms×Psum1 by using the multiplier 121 and then shift to the right as much as N-bits), and store the result in the memory 110.

Then, the processor 120 may obtain an operation result of (Ms×Psum2)×2^{2N} at the third number of times of repetition, and store the result in the memory 110.

Then, the processor 120 may obtain an operation result of (Ms×Psum3)×2^{3N} at the fourth number of times of repetition, and store the result in the memory 110.

According to an embodiment, the processor 120 may perform an accumulation operation for the plurality of operation results stored in the memory by using the accumulator 122, and then perform a shift operation according to 2^{-ms}, and thereby obtain a quantized output value Oqnt.

Meanwhile, in the aforementioned embodiment, specific numbers, specific number of times of repetition, etc. are merely examples for the convenience of explanation, and the disclosure is obviously not limited thereto.

Meanwhile, according to an embodiment of the disclosure, the number of times of repetition may be reduced under a specific condition (e.g., an overflow), and the bit width of the memory 110 may be reduced.

For example, as a requantized output value is data of Q-bits, the maximum output value is 2^{Q}-1. Also, as ms of the bit shift factor 2^{-ms} for quantization is set as a constant before a convolution operation, the processor 120 may identify whether there is a specific condition, i.e., Overflow (Output=Maximum) at each number of times of repetition, and thereby obtain a quantized output value in an intermediate process of the operation.

Also, the processor 120 according to an embodiment does not store data according to lower bits that would be discarded through a shift operation in the memory 110 at each number of times of repetition, and thus the size of data stored in the memory 110 can be reduced.

For the convenience of explanation for the aforementioned embodiment, a case wherein the bits of the multiplicand and the multiplier of the multiplier 121 are the same (e.g., N=M in N-bits× M-bits) will be assumed.

For example, a case wherein the multiplier 121 performs a multiplication operation of 8bits×8bits, and the multiplicand data Psum is 32bits, the multiplier data Ms is 32bits, and the ms of the bit shift factor 2^{-ms} is 64bits may be assumed. However, the specific numbers are merely examples for the convenience of explanation, and the disclosure is obviously not limited thereto. Also, it is obvious that the bits of the multiplicand and the multiplier can be different.

As explained in FIG. 5, when the multiplicand data Psum of P-bits is divided by N-bits (e.g., 8bits) which is the multiplicand value of the multiplier 121, it may be expressed as the following Equation 10.

$${P}_{s u m} = {P}_{s u m 3} \times {2}^{3 N} + {P}_{s u m 2} \times {2}^{2 N} + {P}_{s u m 1} \times {2}^{N} + {P}_{s u m 0} \qquad Equation 10$$

$${P}_{s u m} = {P}_{s u m 3} \times {( {2}^{8} )}^{3} + {P}_{s u m 2} \times {( {2}^{8} )}^{2} + {P}_{s u m 1} \times {( {2}^{8} )}^{1} + {P}_{s u m 0} ( only when N = 8 bits )$$

Also, when the multiplier data Ms of Ms-bits is divided by M-bits (e.g., 8bits) which is the multiplier value of the multiplier 121, it may be expressed as the following Equation 11.

$${M}_{s} = {M}_{s 3} \times {2}^{3 M} + {M}_{s 2} \times {2}^{2 M} + {M}_{s 1} \times {2}^{M} + {M}_{s 0} \qquad Equation 11$$

$${M}_{s} = {M}_{s 3} \times {( {2}^{8} )}^{3} + {M}_{s 2} \times {( {2}^{8} )}^{2} + {M}_{s 1} \times ( {2}^{8} ) + {M}_{s 0} ( only when M = 8 bits )$$

According to an embodiment, the processor 120 may divide the multiplicand data Psum by the units of the digits corresponding to the first bit (e.g., 8bits), and obtain a plurality of first parameters Psum0 to Psum3.

Also, the processor 120 may divide the multiplier data Ms by the units of the digits corresponding to the first bit (e.g., 8bits), and obtain a plurality of second parameters Ms0 to Ms3.

Then, the processor 120 may identify a plurality of combinations according to a multiplication operation between the plurality of first parameters and the plurality of second parameters, and group the plurality of identified combinations into the units of the first bits, and thereby obtain a plurality of groups.

According to an embodiment, a result value Temp of a multiplication operation between the multiplicand data Psum and the multiplier data Ms may be expressed as the following Equation 12.

$$Temp = {P}_{s u m} \times {M}_{s} = ( {P}_{s u m 3} \times {( {2}^{8} )}^{3} + {P}_{s u m 2} \times {( {2}^{8} )}^{2} + {P}_{s u m 1} \times {( {2}^{8} )}^{1} + {P}_{s u m 0} ) \times ( {M}_{s 3} \times {( {2}^{8} )}^{3} + {M}_{s 2} \times {( {2}^{8} )}^{2} + {M}_{s 1} \times ( {2}^{8} ) + {M}_{s 0} ) = {P}_{s u m 3} {M}_{s 3} \times {( {2}^{8} )}^{6} + ( {P}_{s u m 2} {M}_{s 3} + {P}_{s u m 3} {M}_{s 2} ) \times {( {2}^{8} )}^{5} + ( {P}_{s u m 1} {M}_{s 3} + {P}_{s u m 2} {M}_{s 2} + {P}_{s u m 3} {M}_{s 1} ) \times {( {2}^{8} )}^{4} + ( {P}_{s u m 0} {M}_{s 3} + {P}_{s u m 1} {M}_{s 2} + {P}_{s u m 2} {M}_{s 1} + {P}_{s u m 3} {M}_{s 0} ) \times {( {2}^{8} )}^{3} + ( {P}_{s u m 0} {M}_{s 2} + {P}_{s u m 1} {M}_{s 1} + {P}_{s u m 2} {M}_{s 0} ) \times {( {2}^{8} )}^{2} + ( {P}_{s u m 0} {M}_{s 1} + {P}_{s u m 1} {M}_{s 0} ) \times ( {2}^{8} ) + {P}_{s u m 0} {M}_{s 0} = Temp 6 \times {( {2}^{8} )}^{6} + ( T emp {5}_{0} + T emp {5}_{1} ) \times {( {2}^{8} )}^{5} + ( T emp {4}_{0} + T emp {4}_{1} + T emp {4}_{2} ) \times {( {2}^{8} )}^{4} + ( Temp {3}_{0} + T emp {3}_{1} + T emp {3}_{2} + T emp {3}_{3} ) \times {( {2}^{8} )}^{3} + ( T emp {2}_{0} + T emp {2}_{1} + T emp {2}_{2} ) \times {( {2}^{8} )}^{2} + ( T emp {1}_{0} + Temp {1}_{1} ) \times ( {2}^{8} ) + Temp 0 = T 7 \times {( {2}^{8} )}^{7} + T 6 \times {( {2}^{8} )}^{6} + T 5 \times {( {2}^{8} )}^{5} + T 4 \times {( {2}^{8} )}^{4} + T 3 \times {( {2}^{8} )}^{3} + T 2 \times {( {2}^{8} )}^{2} + T 1 \times {( {2}^{8} )}^{1} + T 0 \times ( {2}^{8} ) \qquad Equation 12$$

Referring to the Equation 12, the plurality of combinations may be Psum3×Ms3× (2⁸)⁶, Psum2×Ms3× (2⁸)⁵, Psum3×Ms2× (2⁸)⁵, Psum1×Ms3× (2⁸)⁴, Psum2×Ms2× (2⁸)⁴, Psum3×Ms1× (2⁸)⁴, Psum0×Ms3× (2⁸) 3, Psum1×Ms2× (2⁸)³, Psum2×Ms1× (2⁸)³, Psum3×Ms0× (2⁸)³, Psum0×Ms2× (2⁸)², Psum1×Ms1× (2⁸)², Psum2×Ms0× (2⁸)², Psum0×Ms1×2⁸, Psum1×Ms0×2⁸, Psum0×Ms0.

The processor 120 according to an embodiment may group the plurality of combinations into the units of the first bit (e.g., 8bits) and obtain a plurality of groups, and the plurality of groups may be as follows.

The first group according to (2⁸)⁰ (referred to as T0 hereinafter)=(Psum0×Ms0 ((=Temp0)),

The second group according to (2⁸)¹ (referred to as T1 hereinafter)=(Psum0×Ms1 (=Temp1₀), Psum1×Ms0 (=Temp1₁)),

The third group according to (2⁸)² (referred to as T2 hereinafter)=(Psum0×Ms2 (=Temp2₀), Psum1×Ms1 (=Temp2₁), Psum2×Ms0 (=Temp2₂)),

The fourth group according to (2⁸)³ (referred to as T3 hereinafter)=(Psum0×Ms3 (=Temp3₀), Psum1×Ms2 (=Temp3₁), Psum2×Ms1 (=Temp3₂), Psum3×Ms0 (=Temp3₃)),

The fifth group according to (2⁸)⁴ (referred to as T4 hereinafter)=(Psum1×Ms3 (=Temp4₀), Psum2×Ms2 (=Temp4₁), Psum3×Ms1 (=Temp4₂)),

The sixth group according to (2⁸)⁵ (referred to as T5 hereinafter)=(Psum2×Ms3 (=Temp5₀), Psum3×Ms2 (=Temp5₁)),

The seventh group according to (2⁸)⁶ (referred to as T6 hereinafter)=(Psum3×Ms3 (=Temp6))

Then, the processor 120 may obtain an intermediate operation value corresponding to the combinations included in the group corresponding to information on the number of times of repetition among the plurality of groups by using the multiplier 121.

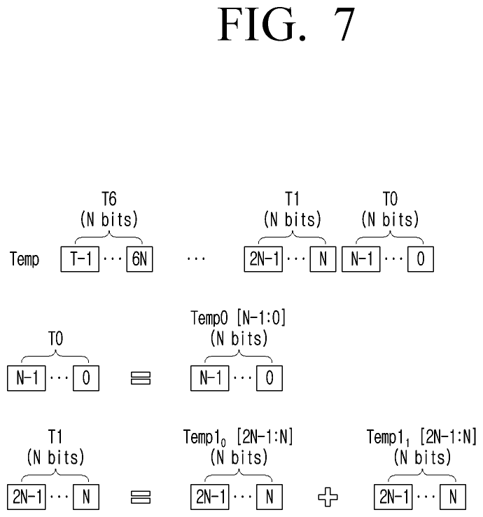

Detailed explanation in this regard will be described with reference to FIG. 7.

FIG. 7 is a diagram for illustrating a plurality of combinations according to a multiplication operation according to an embodiment of the disclosure.

Referring to FIG. 7, a result value Temp of a multiplication operation between the multiplicand data Psum and the multiplier data Ms may be divided into a plurality of groups grouped into the units of the first bit (e.g., T0 to T6).

According to an embodiment, the first group T0 may include one combination (Psum0×Ms0 (=Temp0)).

According to another embodiment, the second group T1 may include two combinations (Psum0×Ms1 (=Temp1₀), Psum1×Ms0 (=Temp1₁)).

Meanwhile, the processor 120 may perform a multiplication operation of each of combinations included in a specific group corresponding to the number of times of repeated operations among the plurality of groups by using the multiplier 121, and thereby obtain intermediate operation values. Then, the processor 120 may obtain a sum of the intermediate operation values as an operation value corresponding to the specific group by using the accumulator 122, and store the value in the memory 110.

According to an embodiment, if the number of times of repeated operations is an initial value (e.g., 0 time (Iteration 0)), the processor 120 may obtain an operation result of the combination included in the first group T0, i.e., Psum0×Ms0 as the intermediate operation value of the first group T0. Meanwhile, as there is one combination included in the first group T0, the operation result of Psum0×Ms0 may be obtained as the operation value of the first group T0, and stored in the memory 110.

According to an embodiment, if the number of times of repeated operations is not an initial value, the processor 120 may perform a multiplication operation of each of combinations included in a specific group corresponding to the number of times of repeated operations among the plurality of groups by using the multiplier 121, and thereby obtain intermediate operation values. Then, the processor 120 may obtain a sum of an operation value stored in the memory 110 right before and the intermediate operation values as the operation value of the specific group by using the accumulator 122, and store the value in the memory 110.

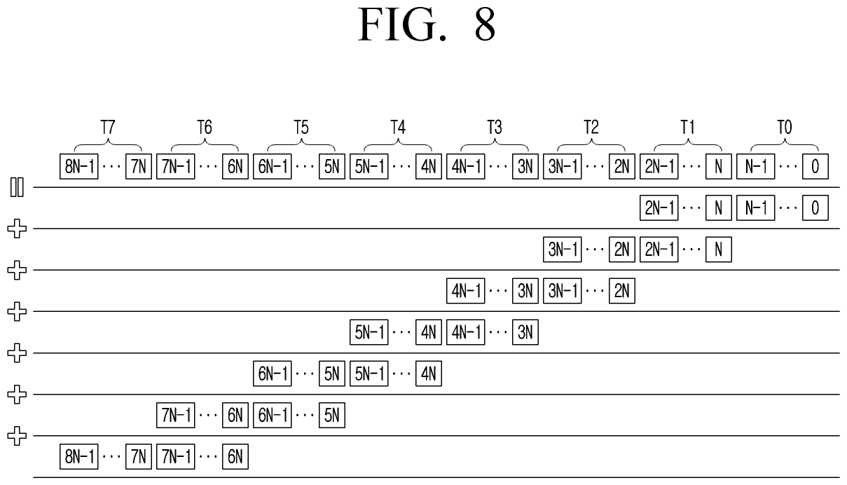

Detailed explanation in this regard will be described with reference to FIG. 8.

FIG. 8 is a diagram for illustrating a plurality of groups that grouped a plurality of combinations according to an embodiment of the disclosure.

### <Iteration 0>

Referring to FIG. 8, first, if the number of times of repeated operations is the initial value, the processor 120 may obtain an operation result of Psum0×Ms0 which is the combination included in the first group T1 among the plurality of groups as the intermediate operation value of the first group T0. Then, the processor 120 may obtain a sum of the obtained intermediate operation value as the operation value of the first group T0.

Meanwhile, the processor 120 may store the remaining numbers (e.g., 2⁸ to 2¹⁵) (referred to as data according to the upper bits hereinafter) excluding the numbers to the digits corresponding to the first bit (e.g., 2⁰ to 2⁷) (referred to as data according to the lower bits hereinafter) in the sum of the intermediate operation values as an operation value corresponding to the first group T0 in the memory 110. Accordingly, the processor 120 may store the data of the upper bits (i.e., 2^{N} to 2^{2N-1}) excluding the data of the lower bits (i.e., 2⁰ to 2^{N-1}) as an operation value corresponding to the group.

Then, the processor 120 may increase the number of times of repeated operations (e.g., one time (Iteration 1)).

### <Iteration 1>

Then, the processor 120 may obtain intermediate operation values of each of Psum0×Ms1 and Psum1×Ms0 which are combinations included in the second group T1 corresponding to the number of times of repeated operations among the plurality of groups by using the multiplier 121.

Then, the processor 120 may obtain a sum of an operation value stored in the memory 110 right before, i.e., the operation value corresponding to the first group T0 and the intermediate operation values of the second group T1.

The processor 120 according to an embodiment may store the remaining numbers (e.g., 2⁸ to 2¹⁵) excluding the numbers to the digits corresponding to the first bit (e.g., 2⁰ to 2⁷) (referred to as data according to the lower bits hereinafter) in the sum of the operation value corresponding to the first group T0 and the intermediate operation values of the second group T1 as an operation value corresponding to the first group T0 in the memory 110.

Then, the processor 120 may increase the number of times of repeated operations (e.g., twice (Iteration 2)).

Referring to FIG. 8, according to an embodiment, the processor 120 may perform multiplication and accumulation operations of combinations sequentially included in each of the first group T0 to the sixth group T6 (or, the seventh group T7) by using the multiplier 121 and the accumulator 122.

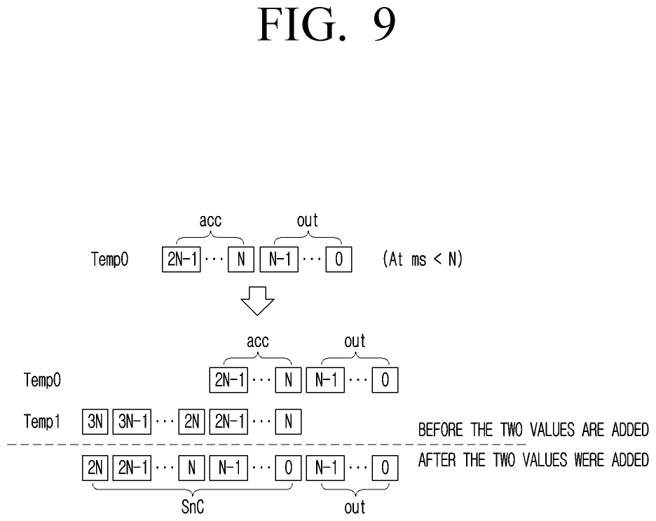

Detailed explanation in this regard will be described with reference to FIG. 9.

FIG. 9 is a diagram for illustrating an accumulation operation among a plurality of groups according to an embodiment of the disclosure.

Referring to FIG. 9, for the convenience of explanation, the first group corresponding to the current number of times of repeated operations will be defined as T0, a sum (e.g., a result of an accumulation operation by using the accumulator 122) of the intermediate operation values (e.g., a result of a multiplication operation by using the multiplier 121) of the combinations included in the first group will be defined as Temp0, the data according to the lower bits in Temp0 will be defined as out, and the data according to the upper bits in Temp0 will be defined as acc.

First, the processor 120 may obtain intermediate operation values by performing a multiplication operation based on the combinations included in the first group corresponding to the current number of times of repeated operations by using the multiplier 121, and obtain a sum of the intermediate operation values by performing an accumulation operation by using the accumulator 122.

Then, the processor 120 may store the data acc according to the upper bits excluding the data according to the lower bits out in the sum of the intermediate operation values as an operation value corresponding to the first group T0 in the memory 110.

Then, the processor 120 may increase the number of times of repeated operations.

Then, the processor 120 may obtain intermediate operation values by performing a multiplication operation based on the combinations included in the second group T1 corresponding to the increased number of times of repeated operations by using the multiplier 121, and obtain a sum of the intermediate operation values (e.g., Temp1) by performing an accumulation operation by using the accumulator 122.

Then, the processor 120 may obtain a sum (referred to as SnC hereinafter) of the operation value stored in the memory 110 right before (e.g., acc) and the sum of the intermediate operation values corresponding to the second group T1 (e.g., Temp1) by using the accumulator 122.

Meanwhile, the processor 120 may identify whether to repeat (or, end) the operation based on the SnC, the out, and the ms of the bit shift factor 2^{-ms}.

For example, if repetition of the operations is identified (e.g., ms≥the first bit N), the processor 120 increases the number of times of repeated operations, and defines the data according to the lower bits of SnC (e.g., 2⁰ to 2⁷) as out, and defines the data according to the upper bits (e.g., 2⁸ to 2¹⁵) as an operation value acc of the group.

As another example, if ending of the operations is identified (e.g., ms<the first bit N), the processor 120 may identify whether a specific condition (e.g., an overflow) occurs, and output quantized multiplicand data Qout based on the SnC and the out.

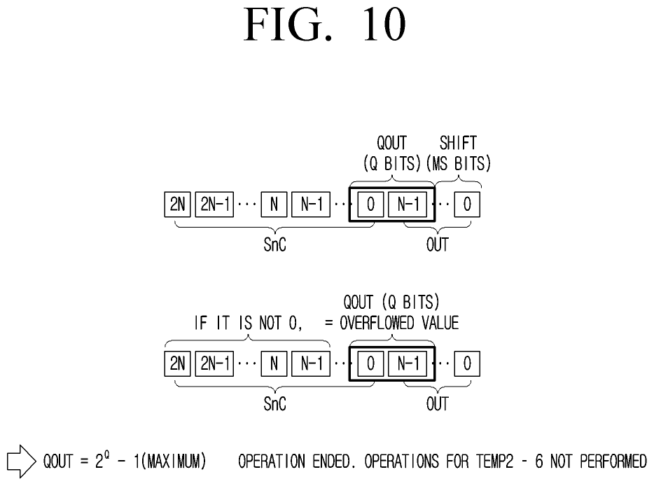

Detailed explanation in this regard will be described with reference to FIG. 10.

FIG. 10 is a diagram for illustrating a condition for ending an operation according to an embodiment of the disclosure.

Referring to FIGS. 9 and 10, if the remaining number excluding the number corresponding to the first bit in the ms of the bit shift factor 2^{-ms} by the number of times of repeated operations (e.g., Iteration #) is smaller than the number corresponding to the first bit (expressed as the following Equation 13), the processor 120 may obtain intermediate operation values corresponding to combinations included in a specific group corresponding to the number of times of repeated operations (e.g., Temp1), and add the values to the operation value of the group corresponding to the number of times of repeated operations right before (acc in Temp0).

$$m s - ( interation \# ) \times ( N bits ) < N \qquad Equation 13$$

N means the number corresponding to the first bit, and Iteration #means the number of times of repeated operations.

A sum of the intermediate operation values corresponding to combinations included in a specific group corresponding to the number of times of repeated operations (e.g., Temp1) and an operation value of the group corresponding to the number of times of repeated operations right before (acc in Temp0) is defined as SnC.

Then, the processor 120 may output quantized multiplicand data Qout based on the SnC and the data according to the lower bits of the group corresponding to the number of times of repeated operations right before (acc in Temp0).

As an example, if the value of the digits from 2^{(ms-(iteration #)×(N))} to 2^{2N} in the SnC is not 0, the processor 120 may identify it as an overflow, and output 2^{Q}-1 (Maximum) which is an overflow value as the quantized multiplicand data Qout. Then, the processor 120 may end the operation.

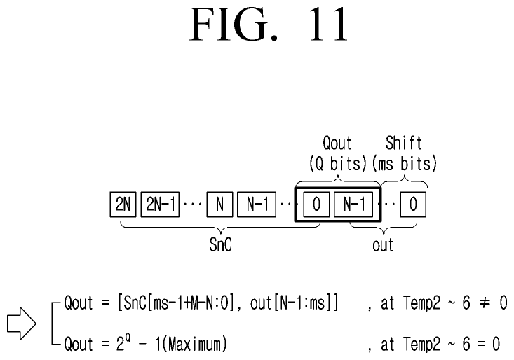

FIG. 11 is a diagram for illustrating a condition for ending an operation according to an embodiment of the disclosure.

Referring to FIG. 11, as an example, if the remaining number excluding the number corresponding to the first bit in the ms of the bit shift factor 2^{-ms} by the number of times of repeated operations (e.g., Iteration #) is smaller than the number corresponding to the first bit, the processor 120 may obtain intermediate operation values corresponding to combinations included in a specific group corresponding to the number of times of repeated operations (e.g., Temp1), and add the values to the operation value of the group corresponding to the number of times of repeated operations right before (acc in Temp0).

A sum of the intermediate operation values corresponding to combinations included in a specific group corresponding to the number of times of repeated operations (e.g., Temp1) and an operation value of the group corresponding to the number of times of repeated operations right before (acc in Temp0) is defined as SnC.

If the value of the digits from 2^{(ms-(iteration #)×(N))} to 2^{2N} in the SnC is 0, the processor 120 may identify that it is not an overflow.

Then, the processor 120 may output the values corresponding to the digits from 2^{(ms-(iteration #)×(N))} to 2^{N-1} in the data according to the lower bits of the group corresponding to the number of times of repeated operations right before (out in Temp0), and from 2⁰ to 2^{(ms-(iteration #)×(N))-1+M-N} in the SnC as the quantized multiplicand data Qout.

$$Qout [ SnC [ m s - 1 + M - N : 0 , out [ N - 1 : m s ] ] , at Temp 2 \sim 6 = 0 \qquad Equation 14$$

$$Qout = {2}^{Q} - 1 ( Maximum ) , at Temp 2 \sim 6 \neq 0$$

Then, the processor 120 may end the operation.

For the convenience of explanation, hereinafter, the multiplicand data Qout quantized by using the multiplier 121 and the accumulator 122 will be explained by assuming specific numbers.

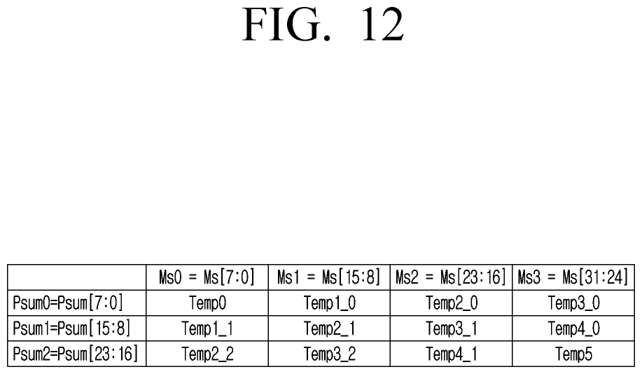

FIG. 12 is a diagram for illustrating multiplicand data and multiplier data of 24bits according to an embodiment of the disclosure.

For example, the multiplicand data Psum will be assumed as 10000000₁₀, the multiplier data Ms will be assumed as 23413412₁₀, and the ms of the bit shift factor will be assumed as 40.

According to an embodiment, the multiplicand data Psum is 10000000₁₀=1001100010010110100000002, and the multiplier data Ms is 23413412₁₀=10110010101000010101001002.

According to an embodiment, the processor 120 may divide 100110001001011010000000₂ into the units of the first bit. For example, the multiplicand data Psum is expressed as the following Equation 15.

$$Psum = Psum 0 \times {( {2}^{8} )}^{0} + Psum 1 \times {( {2}^{8} )}^{1} + Psum 2 \times {( {2}^{8} )}^{2} = 10000000 \times {( {2}^{8} )}^{0} + 10010110 \times {( {2}^{8} )}^{1} + 10011000 \times {( {2}^{8} )}^{2} \qquad Equation 15$$

According to an embodiment, the processor 120 may divide 1011001010100001010100100₂ into the units of the first bit. For example, the multiplier data Ms is expressed as the following Equation 16.

$$Ms = Ms 0 \times {( {2}^{8} )}^{0} + Ms 1 \times {( {2}^{8} )}^{1} + Ms 2 \times {( {2}^{8} )}^{2} + Ms 3 \times {( {2}^{8} )}^{3} = 1010010 \; 0 \times {( {2}^{8} )}^{0} + 1000010 \times {( {2}^{8} )}^{1} + 1100101 \times {( {2}^{8} )}^{2} + 1 \times {( {2}^{8} )}^{3} \qquad Equation 16$$

Then, the processor 120 may identify a plurality of combinations according to a multiplication operation between the plurality of first parameters corresponding to the multiplicand data Psum (Psum0 to Psum2) and the plurality of second parameters corresponding to the multiplier data Ms (Ms0 to Ms3).

Then, the processor 120 may group the plurality of combinations into the units of the first bit (e.g., 8bits), and obtain a plurality of groups.

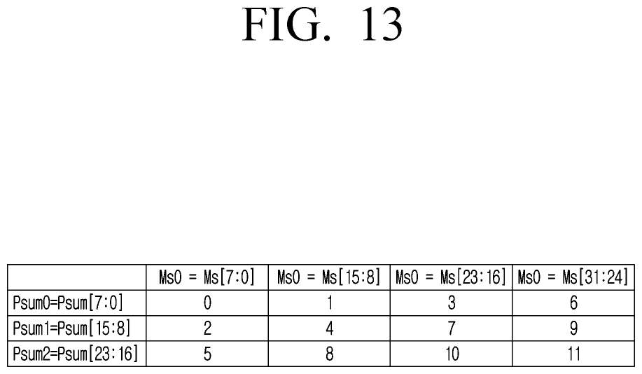

Meanwhile, the processor 120 may perform a multiplication operation for the plurality of combinations sequentially by using the multiplier 121, and detailed explanation in this regard will be described with reference to FIG. 13.

FIG. 13 is a diagram for illustrating operation orders of each of a plurality of combinations according to a multiplication operation according to an embodiment of the disclosure.

Referring to FIG. 13, if the number of times of repeated operations is an initial value (e.g., Iteration 0), the processor 120 may obtain a result value of Psum0×Ms0 (=Temp0) included in the first group among the plurality of groups by using the multiplier 121.

Then, the processor 120 may increase the number of times of repeated operations, and according to the increased number of times of repeated operations (e.g., Iteration 1), the processor 120 may sequentially obtain the result values of each of Psum0×Ms1 (=Temp1₀) and Psum1×Ms0 (=Temp1₁) included in the second group among the plurality of groups by using the multiplier 121.

Then, the processor 120 may increase the number of times of repeated operations, and according to the increased number of times of repeated operations (e.g., Iteration 2), the processor 120 may sequentially obtain the result values of each of Psum0×Ms2 (=Temp2₀), Psum1×Ms1 (=Temp2₁), and Psum2×Ms0 (=Temp2₂) included in the third group among the plurality of groups by using the multiplier 121.

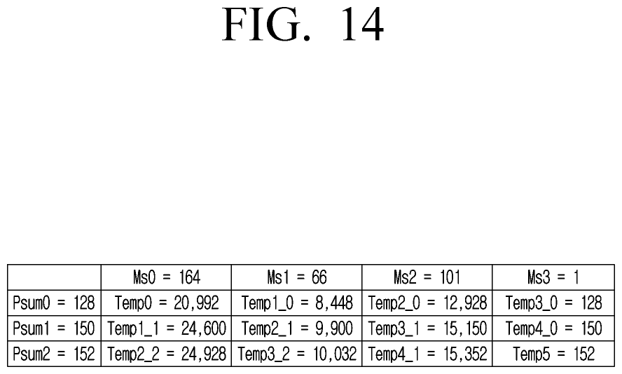

For the convenience of explanation, the result values corresponding to each of the plurality of combinations will be explained with reference to FIG. 14.

FIG. 14 is a diagram for illustrating operation results of each of a plurality of combinations according to an embodiment of the disclosure.

Referring to FIG. 14, result values were described in decimal numbers for the convenience of explanation.

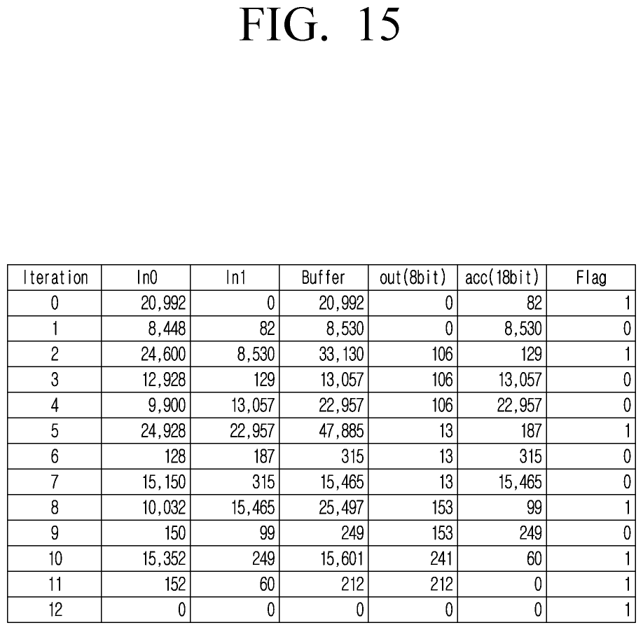

FIG. 15 is a diagram for illustrating an operation result according to information on the number of times of repetition according to an embodiment of the disclosure.

Referring to FIGS. 14 and 15, each of SnC, acc, and out obtained by using the multiplier 121 and the accumulator 122 according to information on the number of times of repetition will be explained.

### <Iteration 0>

First, if the number of times of repeated operations is the initial value (e.g., Iteration 0), the processor 120 may obtain 20992₁₀=101001000000000₂ which is a result value of Psum0×Ms0 (=Temp0) included in the first group among the plurality of groups by using the multiplier 121.

Then, the processor 120 may add the result values of multiplication operations of each of the combinations included in the first group (referred to as intermediate operation values hereinafter) by using the accumulator 122, and define the data according to the lower bits in the sum of the intermediate operation values as out, and define the data according to the upper bits as acc. For example, the processor 120 may define 00000000 corresponding to the lower bits in 1010010 00000000₂ as out, and define 1010010 as acc. Then, the processor 120 may increase the number of times of repeated operations.

### <Iteration 1>

Then, as the remaining number excluding the number corresponding to the first bit in the ms of the bit shift factor by the number of times of repeated operations is greater than or equal to the number corresponding to the first bit (40−1*8≥8, 40 is ms, 1 is the number of times of repeated operations, and 8 is the number corresponding to the first bit), the processor 120 may repeat the operations.

The processor 120 according to an embodiment may add the result values of the multiplication operations of each of the plurality of combinations (Psum0×Ms1 (=Temp1₀), Psum1×Ms0 (=Temp1₁)) included in the second group corresponding to the increased number of times of repeated operations (i.e., Iteration 1), and the acc stored in the memory 110.

For example, the processor 120 may obtain Psum0×Ms1 (=Temp1₀)=8448₁₀=10000100000000₂ and Psum1×Ms0 (=Temp1₁)=24600₁₀=110000000011000₂, and add them to the acc=1010010₂ stored in the memory 110.

Then, the processor 120 may obtain 33130₁₀=1000000101101010₂ which is a sum of the sum of the intermediate operation result values of the second group (Temp1) and the acc stored in the memory 110 as SnC.

Then, the processor 120 may increase the number of times of repeated operations.

### <Iteration 2>

Then, as the remaining number excluding the number corresponding to the first bit in the ms of the bit shift factor by the number of times of repeated operations is greater than or equal to the number corresponding to the first bit (40−2*8≥8, 40 is ms, 2 is the number of times of repeated operations, and 8 is the number corresponding to the first bit), the processor 120 may repeat the operations.

The processor 120 according to an embodiment may define the data according to the upper bits excluding the data according to the lower bits in the SnC stored in the memory 110 as acc.

For example, the processor 120 may exclude 1101010 in SnC=33130₁₀=1000000101101010₂, and define 10000001₂=129₁₀ as acc.

The processor 120 according to an embodiment may add the result values of the multiplication operations of each of the plurality of combinations (Psum0×Ms2 (=Temp2₀), Psum1×Ms1 (=Temp2₁), Psum2×Ms0 (=Temp2₂)) included in the third group corresponding to the increased number of times of repeated operations (i.e., Iteration 2), and the acc stored in the memory 110.

For example, the processor 120 may obtain Psum0×Ms2 (=Temp2₀)=12928₁₀=11001010000000₂, Psum1×Ms1 (=Temp2₁)=9900₁₀=10011010101100₂, and Psum2×Ms0 (=Temp2₂)=24928₁₀=110000101100000₂, and add them to the acc=10000001₂=129₁₀ stored in the memory 110.

Then, the processor 120 may obtain 47885₁₀=1011101100001101₂ which is a sum of the sum of the intermediate operation result values of the third group (Temp2) and the acc stored in the memory 110 as SnC.

Then, the processor 120 may increase the number of times of repeated operations.

### <Iteration 3>

Then, as the remaining number excluding the number corresponding to the first bit in the ms of the bit shift factor by the number of times of repeated operations is greater than or equal to the number corresponding to the first bit (40−3*8≥8, 40 is ms, 3 is the number of times of repeated operations, and 8 is the number corresponding to the first bit), the processor 120 may repeat the operations.

The processor 120 according to an embodiment may define the data according to the upper bits excluding the data according to the lower bits in the SnC stored in the memory 110 as acc.

For example, the processor 120 may exclude 1101 in SnC=47885₁₀=1011101100001101₂, and define 10111011₂=187₁₀ as acc.

The processor 120 according to an embodiment may add the result values of the multiplication operations of each of the plurality of combinations (Psum0×Ms3 (=Temp3₀), Psum1×Ms2 (=Temp3₁), Psum2×Ms1 (=Temp3₂)) included in the fourth group corresponding to the increased number of times of repeated operations (i.e., Iteration 3), and the acc stored in the memory 110.

For example, the processor 120 may obtain Psum0×Ms3 (=Temp3₀)=128₁₀=10000000₂, Psum1×Ms2 (=Temp3₁)=15150₁₀=11101100101110₂, and Psum2×Ms1 (=Temp3₂)=10032₁₀=10011100110000₂, and add them to the acc=10111011₂=187₁₀ stored in the memory 110.

Then, the processor 120 may obtain 25497₁₀=110001110011001₂ which is a sum of the sum of the intermediate operation result values of the fourth group (Temp3) and the acc stored in the memory 110 as SnC.

Then, the processor 120 may increase the number of times of repeated operations.

### <Iteration 4>

Then, as the remaining number excluding the number corresponding to the first bit in the ms of the bit shift factor by the number of times of repeated operations is greater than or equal to the number corresponding to the first bit (40−4*8≥8, 40 is ms, 4 is the number of times of repeated operations, and 8 is the number corresponding to the first bit), the processor 120 may repeat the operations.

The processor 120 according to an embodiment may define the data according to the upper bits excluding the data according to the lower bits in the SnC stored in the memory 110 as acc.

For example, the processor 120 may exclude 10011001 in SnC=25497₁₀=110001110011001₂, and define 1100011₂=99₁₀ as acc.

The processor 120 according to an embodiment may add the result values of the multiplication operations of each of the plurality of combinations (Psum1×Ms3 (=Temp4₀), Psum2×Ms2 (=Temp4₁)) included in the fifth group corresponding to the increased number of times of repeated operations (i.e., Iteration 4), and the acc stored in the memory 110.

For example, the processor 120 may obtain (Psum1×Ms3 (=Temp4₀)=150₁₀=10010110₂ and Psum2×Ms2 (=Temp4₁)=15352₁₀=11101111111000₂, and add them to the acc=1100011₂=99₁₀ stored in the memory 110.

Then, the processor 120 may obtain 15601₁₀=11110011110001₂ which is a sum of the sum of the intermediate operation result values of the fifth group (Temp4) and the acc stored in the memory 110 as SnC.

Then, the processor 120 may increase the number of times of repeated operations.

### <Iteration 5>

Then, as the remaining number excluding the number corresponding to the first bit in the ms of the bit shift factor by the number of times of repeated operations is smaller than the number corresponding to the first bit (40−5*8≥8, 40 is ms, 5 is the number of times of repeated operations, and 8 is the number corresponding to the first bit), the processor 120 may identify whether to repeat the operations.

As the data according to the upper bits (i.e., 2ⁿ to 2²ⁿ⁻¹) in Psum2×Ms3 (=Temp5₀)=152₁₀=10011000₂ which is a result value of a multiplication operation of the plurality of combinations (Psum2×Ms3 (=Temp5₀)) included in the sixth group corresponding to the increased number of times of repeated operations (i.e., Iteration 5) is 0, the processor 120 according to an embodiment may identify that it is not an overflow. Accordingly, the processor 120 may repeat the operations.

Then, the processor 120 may define the data according to the upper bits excluding the data according to the lower bits in the SnC stored in the memory 110 as acc.

For example, the processor 120 may exclude 11110001 in SnC=15601₁₀=11110011110001₂, and define 111100₂=60¹⁰ as acc.

Then, the processor 120 may obtain 212₁₀ which is a sum of the sum of the intermediate operation result values of the sixth group (Temp5) and the acc stored in the memory 110 as SnC.

Then, the processor 120 may increase the number of times of repeated operations.

### <Iteration 6>

Then, as the remaining number excluding the number corresponding to the first bit in the ms of the bit shift factor by the number of times of repeated operations is smaller than 0 (40−6*8<0, 40 is ms, 6 is the number of times of repeated operations, and 8 is the number corresponding to the first bit), the processor 120 may end the operation.

Then, the processor 120 may output SnC=212 stored in the memory 110 as the quantized multiplicand data Qout. For example, the processor 120 may output SnC=212₁₀ as the Qout.

Referring to the aforementioned embodiment, as Psum×Ms×2^{-ms}=10000000×23413412×2⁻⁴⁰≈212.9437, the processor 120 may obtain the quantized multiplicand data Qout by using the multiplier 121 (e.g., a multiplier performing a multiplication operation of 8bits×8bits), but not a multiplier dedicated to quantization.

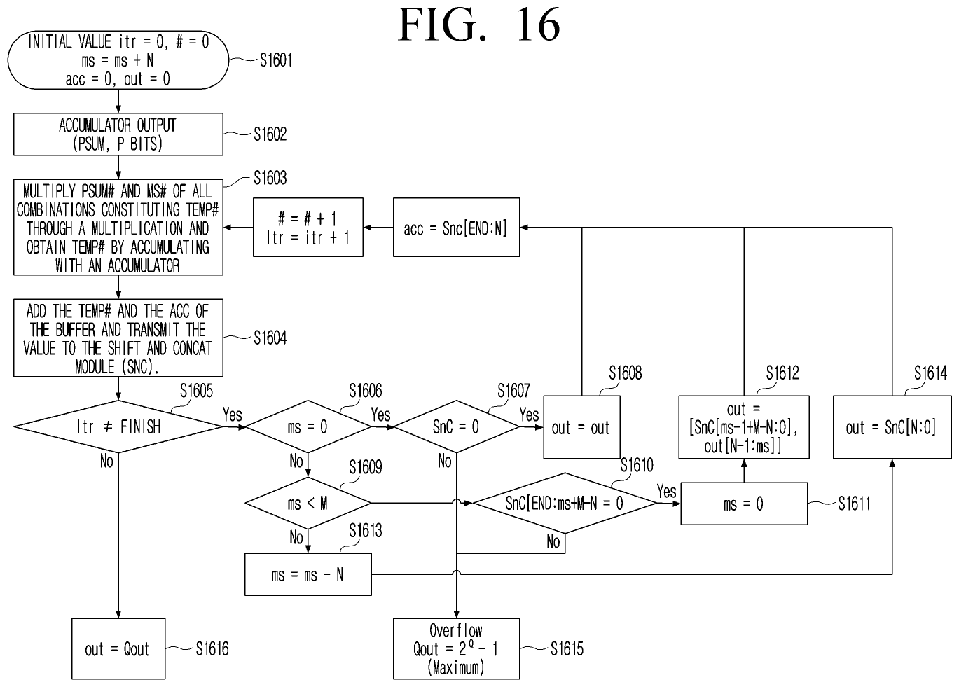

FIG. 16 is a diagram for illustrating a method of obtaining an integer that quantized multiplicand data according to an embodiment of the disclosure.

According to an embodiment, the processor 120 may set each of the number of times of repeated operations, the ms of the bit shift factor, the acc, and the out as initial values in the operation S1601.

According to an embodiment, the processor 120 may obtain the multiplicand data Psum according to a convolution operation between an activation value and a weight value in the operation S1602, and sequentially operate each of a plurality of groups according to the number of times of repeated operations, and obtain Temp #corresponding to each of the plurality of groups in the operation S1603.

According to an embodiment, after the processor 120 obtained an operation value acc corresponding to a second group according to the operations S1601 to S1603, if the remaining number excluding the number corresponding to the first bit in the bit shift factor by the number of times of repeated operations is greater than or equal to the number corresponding to the first bit in the operations S1605: Y, S1606: N, and S1609: N, the processor 120 may obtain third intermediate operation values corresponding to combinations included in a third group according to the number of times of repeated operations among the plurality of groups by using the multiplier 121, and obtain the remaining numbers excluding the numbers to the digits corresponding to the first bit in the sum of a second operation value stored in the memory 110 right before and the third intermediate operation values as a third operation value corresponding to the third group, and increase the number of times of repeated operations by increasing the number of times of repeated operations after storing the third operation value in the memory 110 in the operation S1614.

According to an embodiment, if the remaining number excluding the number corresponding to the first bit in the bit shift factor by the increased number of times of repeated operations is smaller than the number corresponding to the first bit in the operations S1605: Y, S1606: N, and S1609: Y, the processor 120 may obtain fourth intermediate operation values corresponding to combinations included in a fourth group according to the increased number of times of repeated operations, and output an overflow value as the integer based on the numbers from digits corresponding to the remaining numbers to digits corresponding to the first bit in the sum of the third operation value stored in the memory 110 right before and the fourth intermediate operation values in the operations S1610: N and S1615.

If the remaining number excluding the number corresponding to the first bit in the bit shift factor by the increased number of times of repeated operations is zero in the operation S1606: Y, the processor 120 according to an embodiment may obtain fourth intermediate operation values corresponding to combinations included in the fourth group according to the increased number of times of repeated operations, and output the numbers to the digits corresponding to the first bit in the sum of the third operation value stored in the memory 110 right before and the fourth intermediate operation values as the integers in the operations S1607: Y, S1608, S1603, S1604, S1605: N, and S1616.

If the remaining number excluding the number corresponding to the first bit in the bit shift factor by the increased number of times of repeated operations is greater than or equal to the number corresponding to the first bit in the operations S1605: Y, S1606: N, and S1609: N, the processor 120 according to an embodiment may obtain third intermediate operation values corresponding to combinations included in a third group according to the number of times of repeated operations among the plurality of groups by using the multiplier 121 in the operation S1614.

Also, if the remaining number excluding the numbers to the digits corresponding to the first bit in the sum of a second operation value stored in the memory 110 right before and the third intermediate operation values is zero in the operation S1607: Y, the processor 120 according to an embodiment may output the numbers to the digits corresponding to the first bit as the integers in the operations S1608, S1604, S1605, and S1616.

Meanwhile, the operations S1601, S1602, S1603, S1604, S1605, S1606, S1607, S1608, S1609, S1610, S1611, S1612, S1613, S1614, S1615 and S1616 according to the flow chart illustrated in FIG. 16 may be expressed as the following pseudo code.

TABLE 1

| Initial ms = ms + 8 | |
|---|---|
| If flag = 0: | |
| acc = SnC | // 18 bit |

| If ms = 0: | |
|---|---|
| Check overflow | |
| out = out | // 8 bit |
| else if 0 < ms < 8: | |
| Check overflow | |
| out = {SnC[ms−1:0], out[7:ms]} | // 8 bit |
| ms = 0 | |
| else if 8≤ms | |
| out = SnC [7:0] | // 8 bit |

| ms = ms − 8; | |
|---|---|
| Acc = SnC [17:8] | // 10 bit |

In a control method for an electronic device including a multiplier, an accumulator, and memory according to an embodiment of the disclosure, first, multiplicand data according to a convolution operation between an activation value and a weight value is obtained by using the multiplier and the accumulator, and the data is stored in the memory. Then, based on a first scale factor for quantizing the activation value, a second scale factor for quantizing the weight value, and a third scale factor for quantizing the multiplicand data, multiplier data and a bit shift factor are obtained, and they are stored in the memory.

Then, an integer that quantized the multiplicand data according to a multiplication operation among the multiplicand data, the multiplier data, and the bit shift factor is obtained by using the multiplier.

The operation of obtaining the integer according to an embodiment may include the operations of dividing the multiplicand data into units of digits corresponding to a first bit and obtaining at least one first parameter, dividing the multiplier data into the units of the digits corresponding to the first bit and obtaining at least one second parameter, identifying a plurality of combinations according to a multiplication operation between the at least one first parameter and the at least one second parameter, grouping the plurality of identified combinations into the units of the first bit and obtaining a plurality of groups, obtaining first intermediate operation values corresponding to combinations included in a first group according to the number of times of repeated operations among the plurality of groups by using the multiplier, obtaining a sum of the first intermediate operation values by using the accumulator, and obtaining the remaining numbers excluding the numbers to the digits corresponding to the first bit in the sum of the first intermediate operation values as a first operation value corresponding to the first group, and storing the value in the memory.

The operation of obtaining the first operation value may include the operation of, based on the number of times of repeated operations corresponding to a set value of initialization, obtaining the first operation value based on the sum of the first intermediate operation values, and based on the number of times of repeated operations not corresponding to the set value of initialization, obtaining the first operation value based on a sum of an operation value stored in the memory right before and the first intermediate operation values.

The control method according to an embodiment may further include the operation of increasing the number of times of repeated operations by increasing the number of times of repeated operations after storing the first operation value in the memory.

The operation of obtaining the integer may include the operations of obtaining second intermediate operation values corresponding to combinations included in a second group according to the increased number of times of repeated operations among the plurality of groups by using the multiplier, obtaining a sum of the first intermediate operation value and the second intermediate operation values stored in the memory by using the accumulator, and obtaining the remaining numbers excluding the numbers to the digits corresponding to the first bit in the sum of the first intermediate operation value and the second intermediate operation values as a second operation value corresponding to the second group. Also, the operation of increasing may include the operation of increasing the number of times of repeated operations after storing the second operation value in the memory.

The operation of obtaining the integer according to an embodiment may include the operations of, based on the remaining number excluding the number corresponding to the first bit in the bit shift factor by the number of times of repeated operations being greater than or equal to the number corresponding to the first bit, obtaining third intermediate operation values corresponding to combinations included in a third group according to the number of times of repeated operations among the plurality of groups by using the multiplier, and obtaining the remaining numbers excluding the numbers to the digits corresponding to the first bit in the sum of a second operation value stored in the memory right before and the third intermediate operation values as a third operation value corresponding to the third group. Also, the operation of increasing may include the operation of increasing the number of times of repeated operations by increasing the number of times of repeated operations after storing the third operation value in the memory.

The operation of obtaining the integer may include the operations of, based on the remaining number excluding the number corresponding to the first bit in the bit shift factor by the increased number of times of repeated operations being smaller than the number corresponding to the first bit, obtaining fourth intermediate operation values corresponding to combinations included in a fourth group according to the increased number of times of repeated operations, and outputting an overflow value as the integer based on the numbers from digits corresponding to the remaining numbers to digits corresponding to the first bit in the sum of the third operation value stored in the memory right before and the fourth intermediate operation values.

The operation of obtaining the integer according to an embodiment may include the operations of, based on the remaining number excluding the number corresponding to the first bit in the bit shift factor by the increased number of times of repeated operations being zero, obtaining fourth intermediate operation values corresponding to combinations included in a fourth group according to the increased number of times of repeated operations, and outputting the numbers to the digits corresponding to the first bit in the sum of the third operation value stored in the memory right before and the fourth intermediate operation values as the integers.

The operation of obtaining the integer according to an embodiment may include the operations of, based on the remaining number excluding the number corresponding to the first bit in the bit shift factor by the increased number of times of repeated operations being greater than or equal to the number corresponding to the first bit, obtaining third intermediate operation values corresponding to combinations included in a third group according to the number of times of repeated operations among the plurality of groups by using the multiplier, and based on the remaining number excluding the numbers to the digits corresponding to the first bit in the sum of a second operation value stored in the memory right before and the third intermediate operation values being zero, outputting the numbers to the digits corresponding to the first bit as the integers.

Meanwhile, the methods according to the aforementioned various embodiments of the disclosure may be implemented in forms of applications that can be installed on conventional electronic devices.

Also, the methods according to the aforementioned various embodiments of the disclosure may be implemented just with software upgrade, or hardware upgrade for conventional electronic devices.

In addition, the aforementioned various embodiments of the disclosure may also be performed through an embedded server provided on an electronic device, or an external server of at least one of an electronic device or a display device.

Meanwhile, according to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the embodiments disclosed herein. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. The term ‘non-transitory’ only means that a storage medium does not include signals, and is tangible, but does not indicate whether data is stored in the storage medium semi-permanently or temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or can be distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

In addition, each of the components (e.g.: a module or a program) according to the aforementioned various embodiments may consist of a singular object or a plurality of objects. Further, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Also, operations performed by a module, a program, or other components according to the various embodiments may be executed sequentially, in parallel, repetitively, or heuristically. Or, at least some of the operations may be executed in a different order or omitted, or other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage media, storing instructions; and
at least one processor communicatively coupled to the memory, the at least one processor including:
a multiplier, and
an accumulator,
wherein the instructions, when executed by the at least one processor individually or collectively, cause the electronic device to:
obtain multiplicand data according to a convolution operation between an activation value and a weight value by using the multiplier and the accumulator, and store the data in the memory,
based on a first scale factor for quantizing the activation value, a second scale factor for quantizing the weight value, and a third scale factor for quantizing the multiplicand data, obtain multiplier data and a bit shift factor, and store the multiplier data and the bit shift factor in the memory, and
obtain an integer that quantized the multiplicand data according to a multiplication operation among the multiplicand data, the multiplier data, and the bit shift factor stored in the memory by using the multiplier.

2. The electronic device of claim 1, wherein the instructions, when executed by the at least one processor individually or collectively, further cause the electronic device to:
divide the multiplicand data into units of digits corresponding to a first bit and obtain at least one first parameter,
divide the multiplier data into the units of the digits corresponding to the first bit and obtain at least one second parameter,
identify a plurality of combinations according to a multiplication operation between the at least one first parameter and the at least one second parameter,
group the plurality of identified combinations into the units of the first bit and obtain a plurality of groups,
obtain first intermediate operation values corresponding to combinations included in a first group according to a number of times of repeated operations among the plurality of groups by using the multiplier,
obtain a sum of the first intermediate operation values by using the accumulator; and
obtain remaining numbers excluding numbers to the digits corresponding to the first bit in the sum of the first intermediate operation values as a first operation value corresponding to the first group, and store the value in the memory.

3. The electronic device of claim 2, wherein the instructions, when executed by the at least one processor individually or collectively, further cause the electronic device to:
based on the number of times of repeated operations corresponding to a set value of initialization, obtain the first operation value based on the sum of the first intermediate operation values, and
based on the number of times of repeated operations not corresponding to the set value of initialization, obtain the first operation value based on a sum of an operation value stored in the memory right before and the first intermediate operation values.

4. The electronic device of claim 2, wherein the instructions, when executed by the at least one processor individually or collectively, further cause the electronic device to:
increase the number of times of repeated operations by increasing the number of times of repeated operations after storing the first operation value in the memory.

5. The electronic device of claim 4, wherein the instructions, when executed by the at least one processor individually or collectively, further cause the electronic device to:
obtain second intermediate operation values corresponding to combinations included in a second group according to the increased number of times of repeated operations among the plurality of groups by using the multiplier,
obtain a sum of the first intermediate operation values and the second intermediate operation values stored in the memory by using the accumulator,
obtain remaining numbers excluding the numbers to the digits corresponding to the first bit in the sum of the first intermediate operation values and the second intermediate operation values as a second operation value corresponding to the second group, and
increase the number of times of repeated operations after storing the second operation value in the memory.

6. The electronic device of claim 2, wherein the instructions, when executed by the at least one processor individually or collectively, further cause the electronic device to:
based on remaining number excluding a number corresponding to the first bit in the bit shift factor by the number of times of repeated operations being greater than or equal to the number corresponding to the first bit, obtain third intermediate operation values corresponding to combinations included in a third group according to the number of times of repeated operations among the plurality of groups by using the multiplier,
obtain the remaining numbers excluding the numbers to the digits corresponding to the first bit in the sum of a second operation value stored in the memory right before and the third intermediate operation values as a third operation value corresponding to the third group, and
increase the number of times of repeated operations by increasing the number of times of repeated operations after storing the third operation value in the memory.

7. The electronic device of claim 6, wherein the instructions, when executed by the at least one processor individually or collectively, further cause the electronic device to:
based on the remaining number excluding the number corresponding to the first bit in the bit shift factor by the increased number of times of repeated operations being smaller than the number corresponding to the first bit, obtain fourth intermediate operation values corresponding to combinations included in a fourth group according to the increased number of times of repeated operations, and
output an overflow value as the integer based on the numbers from digits corresponding to the remaining numbers to digits corresponding to the first bit in the sum of the third operation value stored in the memory right before and the fourth intermediate operation values.

8. The electronic device of claim 6, wherein the instructions, when executed by the at least one processor individually or collectively, further cause the electronic device to:
based on the remaining number excluding the number corresponding to the first bit in the bit shift factor by the increased number of times of repeated operations being zero, obtain fourth intermediate operation values corresponding to combinations included in a fourth group according to the increased number of times of repeated operations, and
output the numbers to the digits corresponding to the first bit in the sum of the third operation value stored in the memory right before and the fourth intermediate operation values as the integers.

9. The electronic device of claim 2, wherein the instructions, when executed by the at least one processor individually or collectively, further cause the electronic device to:
based on the remaining number excluding the number corresponding to the first bit in the bit shift factor by increasing a number of times of repeated operations being greater than or equal to the number corresponding to the first bit, obtain third intermediate operation values corresponding to combinations included in a third group according to the number of times of repeated operations among the plurality of groups by using the multiplier, and
based on the remaining number excluding the numbers to the digits corresponding to the first bit in the sum of a second operation value stored in the memory right before and the third intermediate operation values being zero, output the numbers to the digits corresponding to the first bit as the integers.

10. A method performed by an electronic device comprising:
obtaining, by the electronic device, multiplicand data according to a convolution operation between an activation value and a weight value by using a multiplier and an accumulator, and storing, by the electronic device, the data in memory,
based on a first scale factor for quantizing the activation value, a second scale factor for quantizing the weight value, and a third scale factor for quantizing the multiplicand data, obtaining, by the electronic device, multiplier data and a bit shift factor, and storing the multiplier data and the bit shift factor in the memory, and
obtaining, by the electronic device, an integer that quantized the multiplicand data according to a multiplication operation among the multiplicand data, the multiplier data, and the bit shift factor by using the multiplier.

11. The method of claim 10, wherein the obtaining of the integer comprises:
dividing the multiplicand data into units of digits corresponding to a first bit and obtaining at least one first parameter;
dividing the multiplier data into the units of the digits corresponding to the first bit and obtaining at least one second parameter;
identifying a plurality of combinations according to a multiplication operation between the at least one first parameter and the at least one second parameter;
grouping the plurality of identified combinations into the units of the first bit and obtaining a plurality of groups;
obtaining first intermediate operation values corresponding to combinations included in a first group according to a number of times of repeated operations among the plurality of groups by using the multiplier;
obtaining a sum of the first intermediate operation values by using the accumulator;
obtaining remaining numbers excluding the numbers to the digits corresponding to the first bit in the sum of the first intermediate operation values as a first operation value corresponding to the first group; and
storing the value in the memory.

12. The method of claim 11, wherein the obtaining of the first operation value comprises:
based on the number of times of repeated operations corresponding to a set value of initialization, obtaining the first operation value based on the sum of the first intermediate operation values; and
based on the number of times of repeated operations not corresponding to the set value of initialization, obtaining the first operation value based on a sum of an operation value stored in the memory right before and the first intermediate operation values.

13. The method of claim 11, further comprising:
increasing the number of times of repeated operations by increasing the number of times of repeated operations after storing the first operation value in the memory.

14. The method of claim 13,
wherein the obtaining of the integer further comprises:
obtaining second intermediate operation values corresponding to combinations included in a second group according to the increased number of times of repeated operations among the plurality of groups by using the multiplier,
obtaining a sum of the first intermediate operation values and the second intermediate operation values stored in the memory by using the accumulator, and
obtaining the remaining numbers excluding the numbers to the digits corresponding to the first bit in the sum of the first intermediate operation values and the second intermediate operation values as a second operation value corresponding to the second group, and
wherein the increasing comprises:
increasing the number of times of repeated operations after storing the second operation value in the memory.

15. The method of claim 13,
wherein the obtaining of the integer further comprises:
based on the remaining number excluding the number corresponding to the first bit in the bit shift factor by the number of times of repeated operations being greater than or equal to the number corresponding to the first bit, obtaining third intermediate operation values corresponding to combinations included in a third group according to the number of times of repeated operations among the plurality of groups by using the multiplier, and
obtaining the remaining numbers excluding the numbers to the digits corresponding to the first bit in the sum of a second operation value stored in the memory right before and the third intermediate operation values as a third operation value corresponding to the third group, and
wherein the increasing comprises:
increasing the number of times of repeated operations by increasing the number of times of repeated operations after storing the third operation value in the memory.

16. The method of claim 15, further comprising:
based on the remaining number excluding the number corresponding to the first bit in the bit shift factor by the increased number of times of repeated operations being smaller than the number corresponding to the first bit, obtaining fourth intermediate operation values corresponding to combinations included in a fourth group according to the increased number of times of repeated operations, and
outputting an overflow value as the integer based on the numbers from digits corresponding to the remaining numbers to digits corresponding to the first bit in the sum of the third operation value stored in the memory right before and the fourth intermediate operation values.

17. The method of claim 15, further comprising:
based on the remaining number excluding the number corresponding to the first bit in the bit shift factor by the increased number of times of repeated operations being zero, obtaining fourth intermediate operation values corresponding to combinations included in a fourth group according to the increased number of times of repeated operations, and
outputting the numbers to the digits corresponding to the first bit in the sum of the third operation value stored in the memory right before and the fourth intermediate operation values as the integers.

18. The method of claim 11, further comprising:
based on the remaining number excluding the number corresponding to the first bit in the bit shift factor by increasing a number of times of repeated operations being greater than or equal to the number corresponding to the first bit, obtain third intermediate operation values corresponding to combinations included in a third group according to the number of times of repeated operations among the plurality of groups by using the multiplier, and
based on the remaining number excluding the numbers to the digits corresponding to the first bit in the sum of a second operation value stored in the memory right before and the third intermediate operation values being zero, output the numbers to the digits corresponding to the first bit as the integers.

19. One or more non-transitory computer-readable storage media storing one or more computer programs including computer-executable instructions that, when executed by one or more processors of an electronic device individually or collectively, cause the electronic device to perform operations, the operations comprising:
obtaining, by the electronic device, multiplicand data according to a convolution operation between an activation value and a weight value by using a multiplier and an accumulator, and storing, by the electronic device, the data in memory,
based on a first scale factor for quantizing the activation value, a second scale factor for quantizing the weight value, and a third scale factor for quantizing the multiplicand data, obtaining, by the electronic device, multiplier data and a bit shift factor, and storing the multiplier data and the bit shift factor in the memory, and
obtaining, by the electronic device, an integer that quantized the multiplicand data according to a multiplication operation among the multiplicand data, the multiplier data, and the bit shift factor by using the multiplier.

20. The one or more non-transitory computer-readable storage media of claim 19, wherein the obtaining of the integer comprises:
dividing the multiplicand data into units of digits corresponding to a first bit and obtaining at least one first parameter;
dividing the multiplier data into the units of the digits corresponding to the first bit and obtaining at least one second parameter;
identifying a plurality of combinations according to a multiplication operation between the at least one first parameter and the at least one second parameter;
grouping the plurality of identified combinations into the units of the first bit and obtaining a plurality of groups;
obtaining first intermediate operation values corresponding to combinations included in a first group according to a number of times of repeated operations among the plurality of groups by using the multiplier;
obtaining a sum of the first intermediate operation values by using the accumulator;
obtaining remaining numbers excluding the numbers to the digits corresponding to the first bit in the sum of the first intermediate operation values as a first operation value corresponding to the first group; and
storing the value in the memory.
